(19) United States
(12) Patent Application Publication
(10) Pub. No.: US 2012/0284735 A1
(43) Pub. Date: Nov. 8, 2012

(54) Interaction-Based Interface to a Logical Client

(75) Inventor: Michael Helligsø Svinth, Taastrup (DK)

(73) Assignee: Microsoft Corporation, Redmond, WA (US)

(21) Appl. No.: 13/102,353

(22) Filed: May 6, 2011

(51) Int. Cl. G06F 9/44; G06F 3/048

(52) U.S. Cl. 719/329; 715/764; 715/810

(57) ABSTRACT

An interaction-based client interface may be provided. Upon receiving a logical representation of a user interface, the user interface may be rendered for display according to the logical representation. An interaction handler may be assigned to the user interface operative to capture a user action via the interaction handler and provide the captured user action to an application logic model. A result of providing the interaction may be received and the user interface may be updated accordingly.

### BACKGROUND

An interaction-based interface may provide an abstraction layer to a user interface. In conventional systems, modeling a user interface requires a large suite of Application Programming Interfaces (APIs) to be included in order to properly implement and/or test functionality. Additionally, the API suite may include a number of functions that may be irrelevant to an end user, such as color and font controls. In some situations, even those functions actually needed by the end user may be unnecessarily coupled to display elements, which may result in degraded functionality and additional complexity.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

An interaction-based client interface may be provided. Upon receiving a logical representation of a user interface, the user interface may be rendered for display according to the logical representation. An interaction handler may be assigned to the user interface operative to capture a user action via the interaction handler and provide the captured user action to an application logic model. A result of providing the interaction may be received and the user interface may be updated accordingly.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing an interaction-based client interface; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

An interaction-based client interface may be provided. Consistent with embodiments of the present invention, a simplified application programming interface (API) may be provided with an interface for transmitting user interactions to application functionality. For example, a user's selection of a form element, entry of data into a text box, or clicking of a control button are all types of interactions with the user interface. By abstracting each of these interaction types into a common class, the functionality needed by a client device may be greatly simplified. A single function may carry information identifying the type of interaction, any data provided to and/or from the user, and which controls are implicated by the interaction rather than needing specific functions for every type of interaction and/or every control element of an application form.

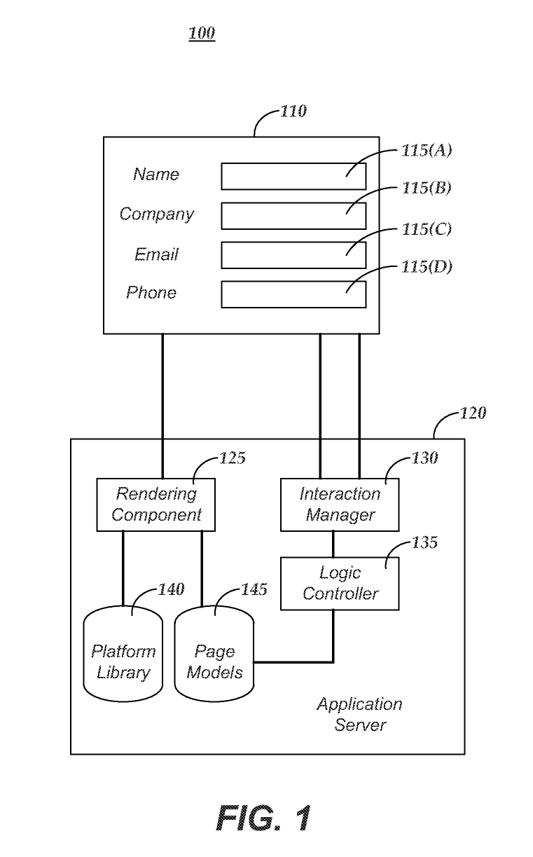

FIG. 1 is a block diagram of an operating environment 100 for providing an interaction-based client interface. Operating environment 100 may comprise a user device 110 operative to display a plurality of form elements 115(A)-(D) associated with an application's function page. User device 110 may comprise, for example, a computer, laptop, tablet device, cellular phone, personal digital assistant (PDA), and/or another computing device operative to display output associated with an executable application. User device 110 may be coupled to an application server 120, which may be operative to execute on user device 110 and/or on another computing device. When executing on another device, the coupling may be via a direct connection, such as a data cable, and/or via a network, such as the Internet, an 802.11 wireless network, a corporate intranet, and/or a cellular data network.

Application server 120 may comprise a rendering component 125, an interaction manager 130, and a logic controller 135. Application server 120 may further comprise a plurality of data sources such as a platform library 140 and a page model library 145. Rendering component 125 may be operative to read a logical model of a page and render a displayable form according to library components associated with a target platform (e.g., user device 110). User device 110 may be operative to detect and/or identify user interactions with any of form elements 115(A)-(D), such as via an input device (e.g., mouse, keyboard, stylus, and/or touch screen). Interaction manager 130 may provide an entry point for invoking user interactions that may be relayed to and performed by logic controller 135.

Upon receiving an interaction from a user, such as entering text in form element 115(A), an appropriate interaction function may be executed by user device 110. The interaction function may comprise an adapter between the displayed interface and logic controller 135. In the case of a button element, for example, the function may hook up to an “onclick” event on the button and call an appropriate Interaction by name and a control ID. Interaction manager 130 may receive the function and invoke the appropriate functionality on the logical model of the user interface. Interaction manager 130 may also coordinate with an observer manager (not shown) that may observe the displayed interface for relevant changes that occur while executing an interaction. Upon completion of the interaction, these changes may be returned to user device 110 via interaction manager 130 and the displayed interface may be updated accordingly.

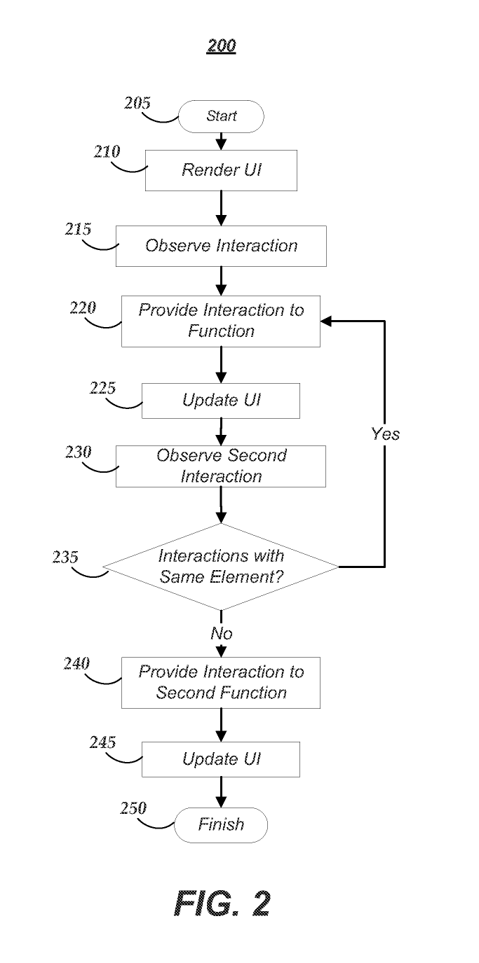

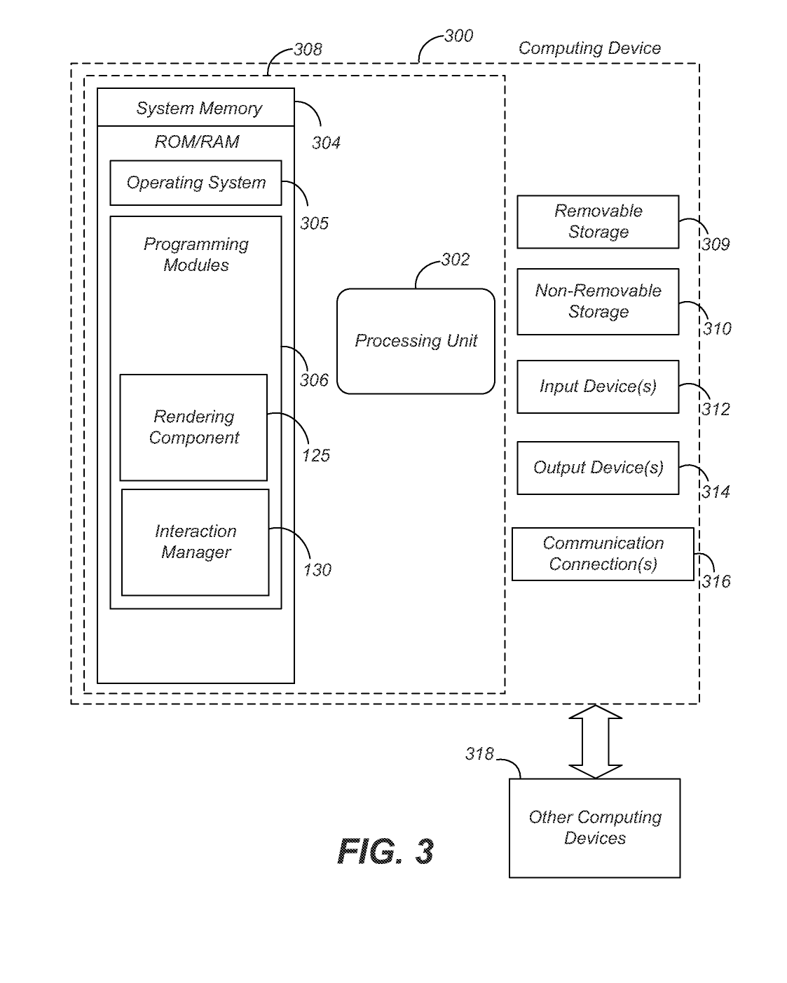

FIG. 2 is a flow chart setting forth the general stages involved in a method 200 consistent with an embodiment of the invention for providing an interaction-based client interface. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may render a user interface according to a logical model. For example, the logical model may comprise a structured array of control elements, each of which may be associated with a unique identifier. The logical model may be stored in page model library 145. The rendered page may comprise a functional user interface associated with an application, such as a front end for a data entry application.

Method 200 may then advance to stage 215 where computing device 300 may observe a first user interaction with a first control element of the user interface. For example, a user may interact with user device 110 via an input mechanism such as a mouse, stylus, keyboard, touchscreen, joystick, or voice command. Such interactions may be classified by type, such as an input of data, an invocation of a control, a closing of a form, a setting of a location, and/or a making of a selection (e.g., a date picker).

Method 200 may then advance to stage 220 where computing device 300 may provide the first user interaction to a first application function via a common programmatic class. For example, a LogicalInteraction base class may be declared comprising a generic invoke method and/or a control element identifier property. A type property may be used to identify a type of the interaction as described above, and/or types may be associated with derived classes that inherit the common base class.

Method 200 may then advance to stage 225 where computing device 300 may update the user interface according to a result received from the application function. For example, user device 110 may perform a call on an API method associated with the rendered page. The API call may comprise the unique identifier associated with a control element, such as one of plurality of form elements 115(A)-(D) and/or an instance of the common programmatic class and/or one of its derivations.

Method 200 may then advance to stage 230 where computing device 300 may observe a second user interaction with the user interface, as described above with respect to stage 215. Method 200 may then advance to stage 235 where computing device 300 may determine whether the second user interaction is associated with the first control element of the user interface. For example, both the first and second interactions may be associated with form element 115(A).

If both interactions were with the same element, method 200 may return to stage 220 where computing device 300 may provide the second user interaction to the first application function. For example, user device 110 may call the same API function that may be associated with form element 115(A).

If the two interactions were with different form elements, method 200 may advance to stage 240 where computing device 300 may provide the second user interaction to the application. For example, a second API function may be associated with the second control element and/or a common API function may be used, with user device 100 providing the unique identifier of the second element as a property.

Method 200 may then advance to stage 245 where computing device 300 may update the user interface according to a second result. For example, a result of the API function call may be received and appropriate rendering to the display of the result may be provided, such as where a user submits a search input and the application returns a search result for display. Method 200 may then end at stage 250.

An embodiment consistent with the invention may comprise a system for providing an interaction-based client interface. The system may comprise a memory storage and a processing unit coupled to the memory storage. The processing unit may be operative to receive a logical representation of a user interface, render the user interface for display according to the logical representation, assign an interaction handler to the user interface, capture a user action via the interaction handler, provide the captured user action to an application logic model, receive a result, and update the user interface, such as by receiving a function result from the application logic model. The user interface may comprise a plurality of control elements, each of which may be associated with an identifier. The processing unit may be further operative to identify a type of the user action and at least one of the plurality of control elements associated with the user action. Providing the captured user action to the application logic model may comprise the processing unit being operative to associate the type of the user action with the identifier associated with the at least one of the plurality of control elements.

Being operative to render the user interface for display may comprise being operative to identify a target platform associated with a display device and display a visual element associated with the identified platform according to a control type identifier associated with at least one of the plurality of control elements. Consistent with embodiments of the invention, the control type identified may be shared across a plurality of target platforms. The processing unit may be further operative to capture a data input associated with the user interaction.

Another embodiment consistent with the invention may comprise a system for providing an interaction-based client interface. The system may comprise a memory storage and a processing unit coupled to the memory storage. The processing unit may be operative to render a user interface according to a logical model, observe a first user interaction with the user interface, provide the first user interaction to an application function, update the user interface according to a result received from the application function, observe a second user interaction with the user interface, provide the second user interaction to the application function, wherein the first user interaction and the second user interaction are provided to the application function via a common programmatic class, and update the user interface according to a second result received from the application function. Being operative to render the user interface may comprise the processing unit being operative to identify a target build platform and display at least one first user interface element defined according to the target build platform. Additional target build platforms may comprise differing user interface element appearances and/or functionality that may be defined by a common control element associated with the logical model of the page.

Yet another embodiment consistent with the invention may comprise a system for providing an interaction-based client interface. The system may comprise a memory storage and a processing unit coupled to the memory storage. The processing unit may be operative to render a user interface according to a logical model, observe a first user interaction with a first control element of the user interface, provide the first user interaction to a first application function via a common programmatic class, and update the user interface according to a result received from the application function. The processing unit may be further operative to observe a second user interaction with the user interface and determine whether the second user interaction is associated with the first control element of the user interface. If the second user interaction is associated with the first control element of the user interface, the processing unit may be operative to provide the second user interaction to the first application function. If the second user interaction is associated with a second control element of the user interface, the processing unit may be operative to provide the second user interaction to a second application function. The processing unit may then be operative to update the user interface according to a second result.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise operating environment 100 as described above. Methods described in this specification may operate in other environments and are not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, such as rendering component 125 and/or interaction manager 130. Operating system 305, for example, may be suitable for controlling computing device 300's operation. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 (e.g. rendering component 125 and/or interaction manager 130) may perform processes including, for example, one or more of method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing an interaction-based client interface, the method comprising:
receiving a logical representation of a user interface;
rendering the user interface for display according to the logical representation;
assigning an interaction handler to the user interface;
capturing a user action via the interaction handler;
providing the captured user action to an application logic model;
receiving a result;
updating the user interface.

2. The method of claim 1, wherein the user interface comprises a plurality of control elements.

3. The method of claim 2, wherein each of the plurality of control elements is associated with an identifier.

4. The method of claim 3, further comprising identifying a type of the user action and at least one of the plurality of control elements associated with the user action.

5. The method of claim 4, wherein providing the captured user action to the application logic model comprises associating the type of the user action with the identifier associated with the at least one of the plurality of control elements.

6. The method of claim 2, wherein rendering the user interface for display comprises identifying a target platform associated with a display device.

7. The method of claim 6, wherein rendering the user interface for display on the identified platform comprises displaying a visual element associated with the identified platform according to a control type identifier associated with at least one of the plurality of control elements.

8. The method of claim 7, wherein the control type identified is shared across a plurality of target platforms.

9. The method of claim 1, further comprising capturing a data input associated with the user interaction.

10. The method of claim 1, wherein updating the user interface comprises receiving a function result from the application logic model.

11. A computer-readable medium which stores a set of instructions which when executed performs a method for providing an interaction-based client interface, the method executed by the set of instructions comprising:
rendering a user interface according to a logical model;
observing a first user interaction with the user interface;
providing the first user interaction to an application function;
updating the user interface according to a result received from the application function;
observing a second user interaction with the user interface;
providing the second user interaction to the application function, wherein the first user interaction and the second user interaction are provided to the application function via a common programmatic class; and
updating the user interface according to a second result received from the application function.

12. The computer-readable medium of claim 11, wherein rendering the user interface comprises:
identifying a target build platform; and
displaying at least one first user interface element defined according to the target build platform.

13. The computer-readable medium of claim 12, further comprising:
identifying a second target build platform; and
displaying at least one second user interface element defined according to the second target build platform, wherein the at least one first user interface element and the at least one second user interface element are each associated with a common control element of the logical model.

14. The computer-readable medium of claim 11, wherein providing the first user interaction to an application function comprises calling a function associated with an application programming interface (API) associated with the logical model.

15. The computer-readable medium of claim 14, wherein the function associated with the API accepts a control element identifier as an argument.

16. The computer-readable medium of claim 15 wherein the logical model comprises a plurality of control element definitions and wherein each of the plurality of control element definitions comprises a unique identifier.

17. The computer-readable medium of claim 14, wherein the function associated with the API accepts the common programmatic class as an argument.

18. The computer-readable medium of claim 17, wherein the first user interaction comprises at least one of the following plurality of interaction types: an input of a value, an invocation of control, a closing of a form, a setting of a location, and a making of a selection.

19. The computer-readable medium of claim 18 wherein each of the plurality of interaction types is associated with a derived programmatic class associated with the common programmatic class.

20. A system for providing an interaction-based client interface, the system comprising:
a memory storage; and
a processing unit coupled to the memory storage, wherein the processing unit is operative to:
render a user interface according to a logical model, wherein the logical model comprises a plurality of control elements and wherein each of the plurality of control elements is associated with a unique identifier,
observe a first user interaction with a first control element of the user interface, wherein the first user interaction comprises at least one of the following plurality of interaction types: an input of a value, an invocation of control, a closing of a form, a setting of a location, and a making of a selection,
provide the first user interaction to a first application function via a common programmatic class, wherein being operative to provide the first user interaction to the application function comprises being operative to provide the unique identifier associated with the first control element and an instance of the common programmatic class to an application programming interface (API) associated with the logical model,
update the user interface according to a result received from the application function,
observe a second user interaction with the user interface,
determine whether the second user interaction is associated with the first control element of the user interface,
in response to determining that the second user interaction is associated with the first control element of the user interface, provide the second user interaction to the first application function, wherein being operative to provide the second user interaction to the application function comprises being operative to provide the unique identifier associated with the first control element and an instance of the common programmatic class to an application programming interface (API) associated with the logical model,
in response to determining that the second user interaction is associated with a second control element of the user interface, provide the second user interaction to a second application function, wherein being operative to provide the second user interaction to the second application function comprises being operative to provide the unique identifier associated with the second control element and a second instance of the common programmatic class to an application programming interface (API) associated with the logical model, and
update the user interface according to a second result.
